(19) United States
(12) Patent Application Publication
(10) Pub. No.: US 2009/0179851 A1
(43) Pub. Date: Jul. 16, 2009

(54) LIGHT SOURCE CONTROL METHOD AND APPARATUS FOR DISPLAY DEVICE

(75) Inventors: Jin Wook KWON, Suwon-si (KR); Sung Sun Kim, Seoul (KR); Mun Kue Park, Suwon-si (KR); Byeong Hoon Park, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/345,104

(22) Filed: Dec. 29, 2008

(30) Foreign Application Priority Data
Dec. 26, 2007 (KR) 2007/0137582

(51) Int. Cl. G09G 3/36; G09G 3/34

(52) U.S. Cl. 345/102; 345/84

(57) ABSTRACT

A light source control method and apparatus for a light source is provided for improving energy utilization efficiency. A light source control apparatus of the present invention includes a display panel which displays video data, a light source which emits light to the display panel, a light source driver which drives the light source, and a panel controller which supplies panel control signals and the video data to the display panel and applies a driver enable signal to the light source driver for activating the light source in synchronization with a time period during which the video data are displayed on the display panel.

### PRIORITY

This application claims priority under 35 U.S.C. § 119(a) to a Korean patent application filed in the Korean Intellectual Property Office on Dec. 26, 2007 and assigned Serial No. 2007-0137582, the disclosure of which is hereby incorporated by reference.

### BACKGROUND OF THE INVENTION

1. Field of the Invention

The present invention generally relates a display device and, in particular, to a light source control method and apparatus for a display device that is capable of improving energy utilization efficiency.

2. Description of the Related Art

Typically, a display device using a Red, Green, and Blue (RGB) color model reproduces a broad array of colors by penetrating light radiated from a signal light source through Red, Green, and Blue color filters. Since the RGB color model uses an optical structure that secures constant color reproduction, the RGB-based display device is provided with a white light source.

FIG. 1 shows a conventional display device, and FIG. 2 shows a signal pattern for operating a light source of the conventional display device of FIG. 1.

The display device of FIG. 1 includes a display panel 13 for displaying video data, a panel controller 11 for controlling display of the video data on the display panel 13, a light source 15 for emitting light to the display panel 13, and a light source driver 17.

The light source driver 17 can operate under the control of a Liquid Crystal Display (LCD) controller, a video processor having RGB interface to the display panel 13, or a video processing module integrated into a mobile application processor. In the display device, a constant electric current is supplied to the light source driver 17 regardless of variation of input voltage level.

As shown in FIG. 2, the control signal is applied to the light source driver 17 constantly without varying in level. Accordingly, as the use time of the display device becomes longer, the display device becomes hotter due to the constant energy supply to the light source driver and light source, whereby additional components are needed for cooling down the display device, such as a cooling fan, a heat radiation plate, etc., resulting in a manufacturing cost increase. Also, the constant energy supply to the light source reduces the lifespan of the light source and increases the energy consumption, resulting in degradation of energy utilization efficiency.

### SUMMARY OF THE INVENTION

In order to overcome the above problems of the prior art, the present invention provides a light source control method and apparatus of a display unit that is capable of reducing energy consumption by decreasing driving time of the light source.

Also, the present invention provides a light source control method and apparatus of a display device that is capable of increasing lifespan of a light source by efficiently controlling energy supply to a light source of the display device.

In accordance with the present invention, a light source control apparatus for a display device includes a display panel which displays video data, a light source which emits light to the display panel, a light source driver which drives the light source, and a panel controller which supplies panel control signals and the video data to the display panel and applies a driver enable signal to the light source driver for activating the light source in synchronization with a time period during which the video data are displayed on the display panel.

The panel control preferably signals include a vertical synchronization signal, a horizontal synchronization signal, a clock signal, and a data enable signal, the driver enable signal being the data enable signal.

The driver enable signal is preferably generated by modifying the data enable signal, the driver enable signal being in a low state for a time period scanning a horizontal blanking region of the display panel.

The light source is preferably activated for a time period when the driver enable signal is in a high state.

The display panel is preferably one of a Liquid Crystal Display (LCD) panel and a Liquid Crystal on Silicon (LCOS) panel.

The video data preferably includes Red, Green, and Blue (RGB) data.

In accordance with another embodiment of the present invention, a light source control method for a display device including a display panel and a light source includes supplying panel control signals and video data to the display panel, and applying a driver enable signal to the light source for driving the light source to emit light during a time period when the video data are displayed on the display panel within a signal frame time.

The panel control signals preferably include a vertical synchronization signal, a horizontal synchronization signal, a clock signal, and a data enable signal, the driver enable signal being the data enable signal.

The driver enable signal is preferably generated by modifying the data enable signal, the driver enable signal being in low state for a time period scanning a horizontal blanking region of the display panel.

The display panel is preferably one of an LCD panel and an LCOS panel.

The video data preferably includes RGB data.

### BRIEF DESCRIPTION OF THE DRAWINGS

The above and other aspects, features and advantages of certain embodiments of the present invention will be more apparent from the following description taken in conjunction with the accompanying drawing, in which:

FIG. 1 is a diagram illustrating a conventional display device;

FIG. 2 is a graph illustrating a signal pattern for operating a light source of the conventional display device of FIG. 1;

FIG. 3 is a block diagram of a mobile terminal according to the present invention;

FIG. 4 is a block diagram of a display unit 140 of FIG. 3;

FIG. 5 is a plan view illustrating a display panel of the display unit according to the present invention; and

FIGS. 6A and 6B are timing diagrams illustrating timings of control signals of the display panel of FIG. 5.

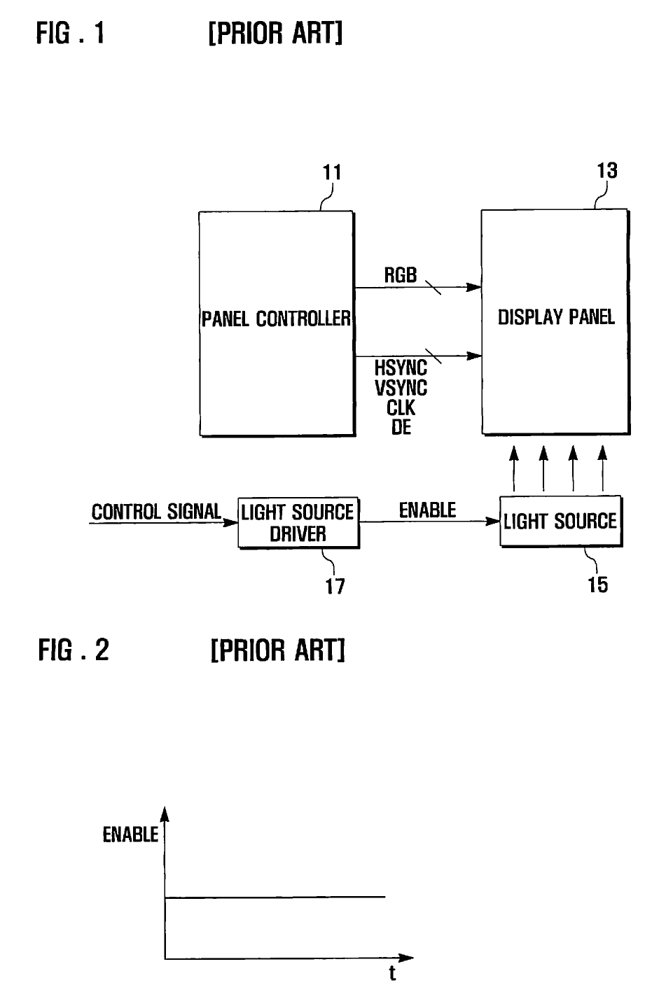

### DETAILED DESCRIPTION OF THE PREFERRED EMBODIMENTS

Preferred embodiments of the present invention will now be described with reference to the accompanying drawings. The same reference numbers are used throughout the drawings to refer to the same or like parts. Descriptions of well-known functions and structures incorporated herein may be omitted to avoid obscuring the subject matter of the present invention.

In the following description, the light source control method and apparatus of the present invention is described in association with a mobile terminal equipped with a display device. However, the present invention is not limited thereto. For example, the light source control method and apparatus can be applied to a dedicated display device and other electric devices having a display module. The mobile terminal can be any of a digital broadcast receiver, Personal Digital Assistant (PDA), Smartphone, Code Division Multiple Access (CDMA) terminal, Global System for Mobile communication (GSM) terminal, General Packet Radio Service (GPRS) terminal, Wideband CDMA (WCDMA) terminal, laptop computer, palm computer, and their equivalent technologies, that are equipped with a display device using a Red, Green, and Blue (RGB) color model.

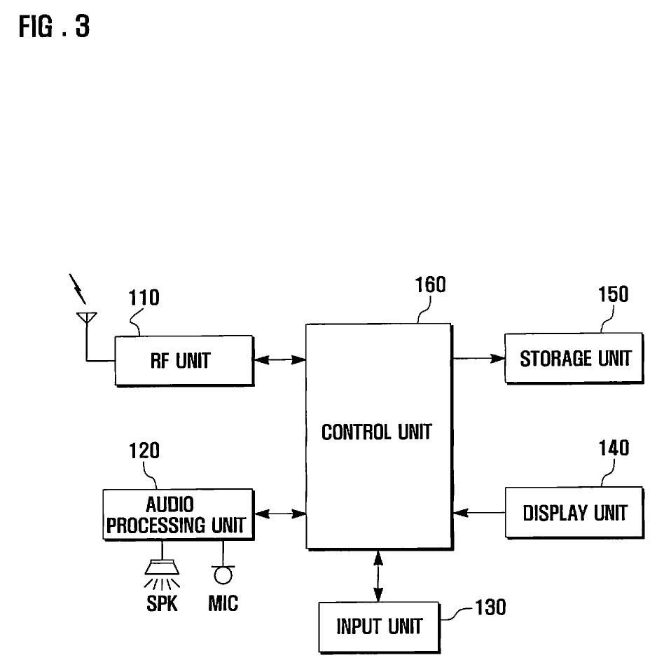

FIG. 3 shows a mobile terminal according to the present invention.

The mobile terminal in FIG. 3 includes a Radio Frequency (RF) unit, an audio processing unit 120, an input unit 130, a storage unit 150, a display unit 140, and a control unit 160.

The RF unit 110 is responsible for establishing a radio channel with a base station. The RF unit 110 converts a radio signal received through an antenna into an intermediate frequency signal and outputs the intermediate frequency signal to the control unit 160, and converts an intermediate frequency signal output by the control unit 160 into a radio signal and transmits the radio signal through the antenna.

The audio processing unit 120 is provided with a microphone (MIC) and a speaker (SPK). The audio processing unit 120 also includes a coder/decoder (codec) and an amplifier. The codec performs Pulse Code Modulation (PCM) on the sound wave input through the microphone and outputs the PCM signal to the control unit 160. The codec also performs PCM demodulation on the audio signal output by the control unit and outputs the demodulated signal through the speaker in the form of an audible sound wave. The amplifier amplifies the sound wave input through the microphone and output through the speaker. The volume of the speaker and microphone gain are adjusted under the control of the control unit 160.

The input unit 130 is provided with a plurality of alphanumeric keys for inputting alphanumeric data and a plurality of function keys for setting and executing various functions of the mobile terminal. The input unit 130 generates a key sequence corresponding to a key input and sends the key sequence to the control unit 160.

The storage unit 150 can be implemented with at least one of Read Only Memory (ROM), Random Access Memory (RAM), Flash memory, etc. The storage unit 150 stores an Operating System (OS) and application programs and data generated during the use of the mobile terminal.

The display unit 140 outputs menus of the mobile terminal, user data input by the user, activated function information, and video data in the form of visual image. The display unit 140 can be implemented with a transmissive Liquid Crystal Display (LCD) or reflective Liquid Crystal on Silicon (LCOS). In a case of using a touchscreen-enabled LCD, the display unit 140 can work as a part of the input unit 130.

The control unit 160 controls voice and data communication functions and other inter components of the mobile terminal. The control unit 160 is provided with a baseband processing part which is a Baseband Analog application-specific integrated circuit (BBA) providing an interface between the control unit 160 and the RF unit 110. The baseband processing part converts a baseband digital signal output by the control unit 160 to an analog Intermediate Frequency (IF) signal and outputs the analog IF signal to the RF unit 110. The baseband processing part also converts the analog IF signal output by the RF unit to a baseband digital signal and sends the baseband digital to the control unit 160.

Although not shown in the drawing, the mobile terminal includes a slot for receiving storage media such as memory card, a connection port for data exchange with an external device, and a power charging port. The mobile terminal may further include a broadcast reception module for receiving digital broadcast signals, an audio playback module for playing digital audio files, camera modules for taking pictures, and other supplementary function modules.

Although only certain kinds of device convergences are set forth by way of example in the above description, it is to be understood, to those skilled in the relevant art, that various digital appliances and modules and their equivalents can be converged with the mobile terminal.

The internal structure of the display unit 140 of FIG. 3 is described hereinafter in more detail.

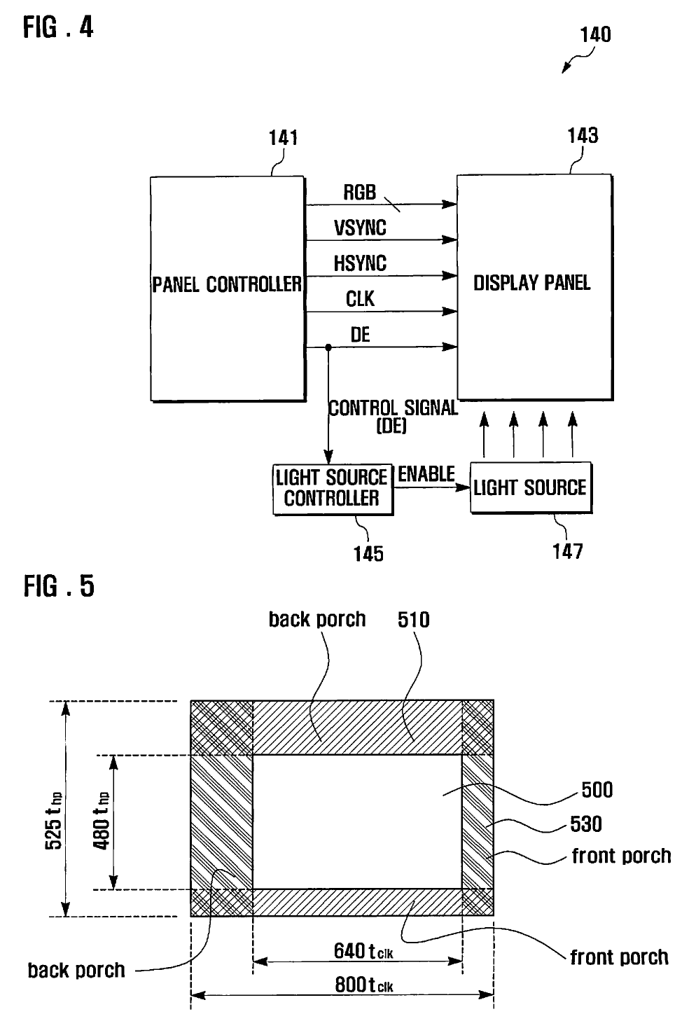

FIG. 4 shows the display unit 140 of FIG. 3.

The display unit 140 in FIG. 4 includes a panel controller 141, a display panel 143, a light source controller 145, and a light source 147.

The panel controller 141 supplies video signals and control signals to the display panel 143 to display a visual image on the screen.

The panel controller 141 can supply the signals to the display panel 143 in two different video interface modes: Central Processing Unit (CPU) interface mode and RGB interface mode. In the CPU interface mode, the RGB data including video signals are transported to a graphic RAM in an LCD driver through a standard interface of 80× (or 68×) system identical with a memory interface, such that RGB data are presented on the display panel 143 in synchronization with an Oscillation Circuit (OSC) signal and a Vertical Horizontal Synchronization (VSYNC) signal of an LCD Driver Integrated Circuit (IC) (LDI). A universal memory bus can be used for LCD interface, and the driving command and RGB data can be advantageously transported through the same bus. The CPU interface mode is optimal for displaying a still screen image and requires transmitting only new image frame data to the LCD module. If new data have not been input, the data buffered in a buffer are presented on the display panel at a preset frame rate, thereby being superior to the RGB interface in low current consumption. The CPU interface mode is appropriated for mobile terminals having small size display panel 143 supporting currently popular Quarter Common Intermediate Format.

In the RGB interface mode, the RGB data are supplied in synchronization with a Horizontal Synchronization signal (HSYNC), a VSYNC signal, and a pixel clock. The frequency of the display panel has to be synchronized with these three signals. In the RGB interface mode, since the LDI is implemented without RAM, it is possible to implement the display unit with low cost in the slim design. Although the RGB interface mode is disadvantageous in consumption current in comparison with the CPU interface mode, it is appropriated for display panels supporting a high resolution such as Video Graphic Array (VGA) and above.

The video signals include RGB data and the panel control signals include the VSYNC, HSYNC, and main clock (CLK).

The panel controller 141 controls the operation of the light source (light source) 147 by applying a light source control signal to the light source controller 145. At this time, the control signal uses a Data Enable (DE) signal among the panel control signals.

The display panel 143 can be implemented with a transmissive LCD panel or a reflective LCOS panel. In this embodiment, the display panel 143 is implemented with a transmissive LCD panel, however the present invention is not limited thereto.

The transmissive LCD panel includes a display device part, a plurality of data Tape Carrier Packages (TCPs), a plurality of gate TCPs, and an integrated Printed Circuit Board (PCB). The display device part includes an array substrate and a color filter substrate joined together and a liquid crystal layer formed between the array substrate and the color filter substrate. The display device part has a plurality of gate lines and a plurality of data lines crossing the gate lines forming pixels at their cross points, and each pixel is implemented with a Thin Film Transistor (TFT) and a Liquid Crystal Capacitor (CLC) and a STorage Capacitor (STC) that are electrically connected to the TFT. The data and gate PCTs are connected to a data driving chip and a gate driving chip, respectively. The data driving chip and gate driving chip supply driving signals for controlling the operations and timings of the display device part. The integrated PCB is electrically connected to the display device part through the plural data TCPs.

The display panel 143 receives panel control signals including the VSYNC, HSYNC, CLK, and DE signals and video signals from the panel controller 141 so as to drive the gate driving chips and data driving chips on the basis of the panel control signals and video signals. The gate driving chips supplies turn-on signals (gate signals) to the TFTs through the gate lines in a sequential order. That is, the gate driving chips activate the gate lines, sequentially. The data driving chips also supply data signals corresponding to the horizontal pixels to the data lines in synchronization with the gate signals.

Although the descriptions are done with an exemplary case in which the gate driving chips are installed on the gate TCP, the gate driving chips can be implemented in a Chip On Glass (COG) method in which the gate driving chips are installed on the array substrate or can be integrated into the gate driving circuit on the array substrate. Also, although the descriptions are done with an exemplary case in which the data driving chips are installed on the data TCP, the data driving chips can be installed on the array substrate. In this case, the data driving chips can be integrated into a single chip.

The light source driver 145 generates an enable signal for driving the light source 147 based on a control signal output by the panel controller 141. The light source driver 145 outputs the enable signal (ENABLE) to the light source 147. The control signal is the DE signal which is one of the panel control signals output by the panel controller 141.

The light source 147 emits in response to the enable signal (ENABLE) output by the light source driver 145. The light source 147 can be provided with a plurality of Light Emitting Diodes (LED), a light emission plate, a light guide plate, a reflection sheet, and optical sheets. The light emission plate is arranged at a side of the light guide plate and has a plurality of LEDs for emitting the incident light to the light guide plate, so the light emitted by the plural LEDs is guided over the light guide plate. A number of the LEDs can be changed according to a size and target brightness of the display panel 143. The light guide plate guides the light emitted by the plural LEDs to the optical sheets facing the light guide plate. The reflection sheet prevents the light emitted by the plural LEDs from leaking outside the light guide plate. That is, the reflection sheet reflects the deviating light to the optical sheets. The optical sheets include a spread sheet for spreading the light penetrated the light guide plate and a prism sheet focuses the spread light. Although the LEDs are arranged here at a side of the display panel, the LEDs and be arranged at the bottom of the display panel 143 (so called, “direct light emission”).

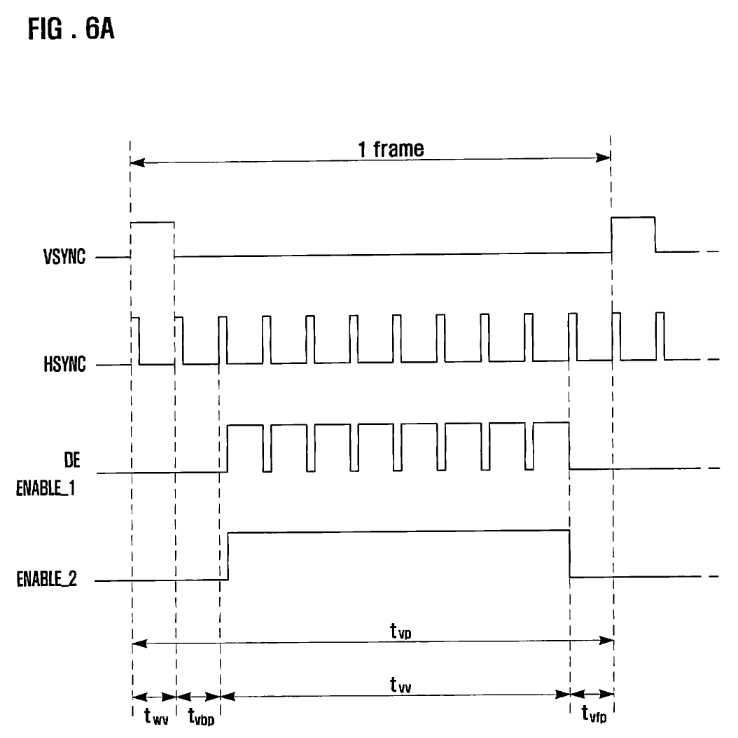

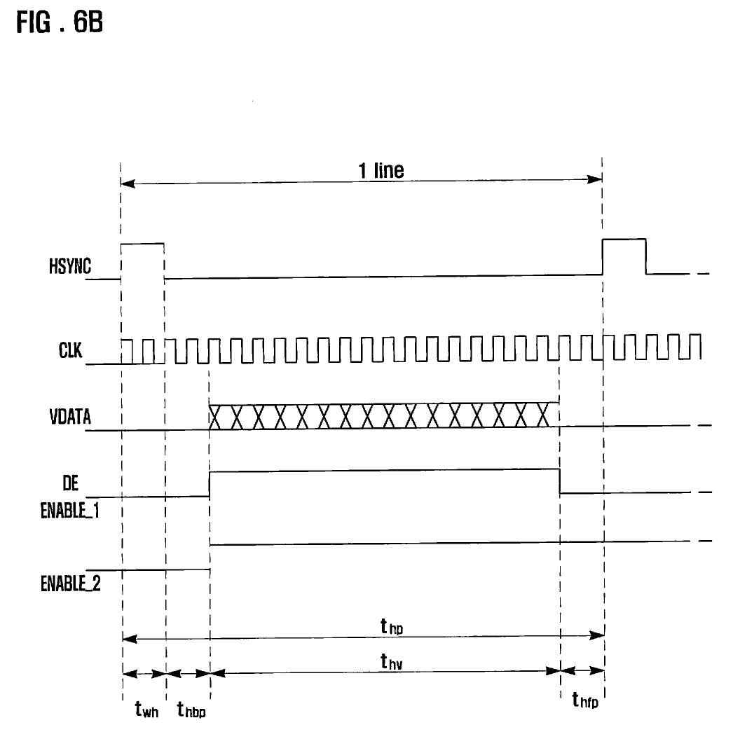

The operations of the display unit of the mobile terminal will now be more specifically described. FIG. 5 shows a display panel of the display unit according to the present invention, and FIGS. 6a and 6b are timing diagrams illustrating timings of control signals of the display panel of FIG. 5.

In FIG. 5, the display panel 143 is provided with a vertical blanking region 510, a horizontal blanking region 530, and a display region 500. The vertical blanking region 510 includes a back porch at the top and a front porch at the bottom of the display panel 143, and the front blanking region 530 includes a back porch at the left and a front porch at the right of the display panel 143. Video data are not supplied to the vertical and horizontal blanking regions 510 and 530, but to the display region 500.

In this embodiment, it is assumed that the display panel 143 supports VGA resolution of 640×480. The display panel 143 operates with the control signal timings as listed in Table 1.

TABLE 1

| | | | | | Real time | | Real time | |
|---|---|---|---|---|---|---|---|---|
| VGA Panel (640*480) | | Symbol | Type | Unit | (60 Hz) | | (120 Hz) | |
| DCLK | Period | tclk | 40 | ns | 40 | ns | 20 | ns |
| | Freq. | fclk | 25 | MHz | 25 | MHz | 50 | MHz |
| HSYNC | Period | thp | 800 | tclk | 32 | μs | 16 | μs |
| | Width | twh | 96 | | 3.84 | μs | 1.96 | μs |
| VSYNC | Period | tvp | 525 | thp | 16.8 | ms | 8.4 | ms |
| | Freq. | fv | 60 | Hz | 60 | Hz | 120 | Hz |
| | Width | tWv | 2 | thp | 64 | μs | 32 | μs |
| DE | H Valid | thv | 640 | tclk | 25.6 | μs | 12.8 | μs |
| | H Backporch | thbp | 40 | | 1.6 | μs | 0.8 | μs |
| | H Frontporch | thfp | 24 | | 0.96 | μs | 0.48 | μs |
| | V Valid | tw | 480 | thp | 15.36 | ms | 7.68 | ms |
| | V Backporch | tvbp | 33 | | 1.056 | ms | 528 | μs |
| | V Frontporch | tvfp | 10 | | 320 | μs | 160 | μs |

In FIGS. 6A and 6B, the timings of the panel control signals and first and second type enable signals (ENABLE_1 and ENABLE_2). The VSYNC is a signal defining a scanning interval of a single frame, and the HSYNC is a signal defining a scanning interval of a single line. The RGB data are presented on the screen when the DE signal is high while the light source 147 emits light and the display panel is activated by the VSYNC and HSYNC signals.

In this embodiment, the light source 147 is configured to be driven when the DE signal is high. That is, the DE signal is used as the control signal of the light source driver 145 for driving the light source 147. Accordingly, when the DE signal is low, the power is not supplied to the LEDs of the light source 147, resulting in an off-state. In this manner, the power consumption by the LEDs of the light source 147 can be reduced without compromising video data presentation.

In the present invention, the DE signal can be used as it is, or can be modified to be used as the enable signal (ENABLE). The raw DE signal is called a first type enable signal (ENABLE_1), and the modified DE signal is called a second type enable signal (ENABLE_2).

A light source control method using the first type enable signal (ENABLE_1) according to the present invention will now be described. In this embodiment, the turn-off time of the LEDs during which the power supply to the LEDs is off is calculated as Equation (1).

Total LED Turn-Off Time=Vertical blank Line*Horizontal duty+Horizontal Active data line*Horizontal blank time (1)

Also, a per-frame power utilization efficiency of the light source control method of this embodiment can be calculated as Equation (2) derived from Equation (1).

Pseudo-PWM Efficiency/frame[%]=Total LED Turn-off Time/frame rate*100 (2)

The LED off time will now be described in more detail with reference to Table 1, Equations (1) and (2), and FIGS. 6A and 6B.

In a case of 60 Hz refresh rate in table 1, the DE signal has a cycle of 32 μs (microseconds) with reference to the HSYNC signal. The high state duration of the DE signal is 25.6 μs. Accordingly, the LEDs turn off for 6.4 μs (32 μs−25.6 μs) per line. This is the value obtained without counting in the scanning time to the horizontal blanking region 530.

With reference to the VSYNC signal, since 45 lines (525-480) exist in the vertical blanking region 510 including the back porch and front porch per frame, the LEDs turn off for 1440 μs (32 μs×45 lines). Also, the low state duration of the DE signal per line is 6.4 μs for 480 lines, the LEDs turn off for 3072 μs (480 lines×6.4 μs). Accordingly, the total LED turn-off time becomes 4512 μs (1440 μs+3072 μs) according to Equation (1). In turn, the per-frame power utilization efficiency becomes 26.86% ((4512 μs/16.8 ms)×100) according to Equation (2).

In a case of 120 Hz refresh rate in table 1, the 120 Hz refresh rate is applied to the display panel 143 since the display panel 143, especially when it is the LCOS panel, may incur a flicker effect with 60 Hz refresh rate in which the screen is flickering.

As shown in Table 1, the DE signal has a cycle of 16 μs with reference to the HSYNC signal. The high state duration of the DE is 12.8 μs. Accordingly, the LEDs turn off for 3.2 μs (16 μs−12.8 μs) per line. This is the value obtained without counting in the scanning time to the horizontal blanking region 530.

With reference to the VSYNC signal, since 45 lines (525-480) exist in the vertical blanking region 510 including the back porch and front porch per frame, the LEDs turn off for 720 μs (16 μs×45 lines). Also, the low state duration of the DE signal per line is 3.2 μs, the LEDs turn off for 1536 μs (480 lines×3.2 μs). Accordingly, the total LED turn-off time becomes 2256 μs ((16×45)+(480×3.2)+1536 μs) according to Equation (1). In turn, the per-frame power utilization efficiency becomes 26.86% according to Equation (2).

In this embodiment, the first type enable signal (ENABLE_1) generated for controlling the light source driver 145 is identical with the DE signal. Accordingly, the light source driver 145 turns on the light source 147 while the DE signal is in high state. As a result, the LEDs of the light source 147 emit the light for the high state of the DE signal. Accordingly, the light source-driving time is saved for the low state of the DE signal.

Since the turn-on delay time and turn-off delay time are 2.4 μs and 2.7 μs, respectively, in the response time of light source 147 to an electric signal, turning on the light source 147 for the high state of the enable signal does not compromise the image quality of the display panel 141.

A light source control method using the second type enable signal (ENABLE_2) according to another embodiment of the present invention will now be described. In this embodiment, the second type enable signal (ENABLE_2) for driving the light source driver 145 is a pulse wave obtained by modifying the DE signal. That is, the second type enable signal (ENABLE_2) is a modified DE signal for controlling such that the light source 147 turns on while scanning on the display region 500 but not the horizontal blanking region 530. The pulse wave of the second type enable signal (ENABLE_2) shown in FIG. 6A is generated by connecting a capacitor having a predetermined capacity to the DE signal line. Preferably, the capacitor is for maintaining the low state of the DE signal. Although the second type enable signal (ENABLE_2) reduces the low state time in comparison with the first type enable signal (ENABLE_1), the turn-on time of the light source 147 is shorten as much as the time required for scanning the horizontal blanking region 530. That is, with a little compromise in power utilization efficiency, using the second type enable signal (ENABLE_2) improves the stability of enable signal supply, in comparison with using the first type enable signal (ENABLE_1).

As described above, the light source control method of the present invention enables reducing the turn-on time of the light source by using the DE signal as a light source enable signal, thereby improving energy utilization efficiency, increasing the lifespan of the light source, and thus reducing management costs. Since the DE signal generated by the panel controller 141 is reused for controlling the light source, there is no need to an additional synchronization process, resulting in improvement of control efficiency.

Although preferred embodiments of the present invention have been described above, it should be clearly understood that many variations and/or modifications of the basic inventive concepts herein taught which may appear to those skilled in the present art will still fall within the spirit and scope of the present invention, as defined in the appended claims.

What is claimed is:

1. A light source control apparatus for a display device, the apparatus comprising:
a display panel which displays video data;
a light source which emits light to the display panel;
a light source driver which drives the light source; and
a panel controller which supplies panel control signals and the video data to the display panel and applies a driver enable signal to the light source driver for activating the light source in synchronization with a time period during which the video data are displayed on the display panel.

2. The light source control apparatus of claim 1, wherein the panel control signals comprise a vertical synchronization signal, a horizontal synchronization signal, a clock signal, and a data enable signal, the driver enable signal being the data enable signal.

3. The light source control apparatus of claim 2, wherein the driver enable signal is generated by modifying the data enable signal, the driver enable signal being in a low state for a time period scanning a horizontal blanking region of the display panel.

4. The light source control apparatus of claim 2, wherein the light source is activated for a time period when the driver enable signal is in a high state.

5. The light source control apparatus of claim 1, wherein the display panel is one of a Liquid Crystal Display (LCD) panel and a Liquid Crystal on Silicon (LCOS) panel.

6. The light source control apparatus of claim 1, wherein the video data comprise Red, Green, and Blue (RGB) data.

7. A light source control method for a display device including a display panel and a light source, the method comprising:
supplying panel control signals and video data to the display panel; and
applying a driver enable signal to the light source for driving the light source to emit light during a time period when the video data are displayed on the display panel within a signal frame time.

8. The light source control method of claim 7, wherein the panel control signals comprise a vertical synchronization signal, a horizontal synchronization signal, a clock signal, and a data enable signal, the driver enable signal being the data enable signal.

9. The light source control method of claim 8, wherein the driver enable signal is generated by modifying the data enable signal, the driver enable signal being in a low state for a time period scanning a horizontal blanking region of the display panel.

10. The light source control method of claim 7, wherein the display panel is one of a Liquid Crystal Display (LCD) panel and a Liquid Crystal on Silicon (LCOS) panel.

11. The light source control method of claim 7, wherein the video data comprise Red, Green, and Blue (RGB) data.
